(19) United States
(12) Patent Application Publication
(10) Pub. No.: US 2009/0040508 A1
(43) Pub. Date: Feb. 12, 2009

(54) Light Monitoring Method and Light Monitoring Apparatus

(75) Inventor: Tokutaka Hara, Funabashi-shi (JP)

Correspondence Address: MERCHANT & GOULD PC, P.O. BOX 2903, MINNEAPOLIS, MN, 55402-0903, US

(73) Assignee: SUMITOMO OSAKA CEMENT CO., LTD., Tokyo (JP)

(21) Appl. No.: 11/886,447

(22) PCT Filed: Mar. 9, 2006
(86) PCT No.: PCT/JP2006/304632

§ 371 Date: Sep. 13, 2007

(30) Foreign Application Priority Data
Mar. 16, 2005 (JP) 2005-075253

(51) Int. Cl. G01N 21/00

(52) U.S. Cl. 356/73.1

(57) ABSTRACT

A light monitoring method and a light monitoring apparatus are provided, in which light propagating optical fibers can be monitored with a simple structure and a small number of components without causing a large connection loss or Fresnel reflection and without performing precise adjustment of optical components. The light monitoring method is characterized in that light leaking from abutting portions obtained by abutting end faces of the optical fibers is received.

### TECHNICAL FIELD

The present invention relates to a light monitoring method of monitoring light propagating through an optical fiber and to a light monitoring apparatus.

The present application claims priority from Japanese Patent Application No. 2005-075253, filed on Mar. 16, 2005, the content of which is incorporated herein by reference.

### BACKGROUND ART

Heretofore, as a light monitoring method of monitoring light propagating through an optical fiber, a spatial-propagation-type light monitoring method shown in FIG. 4A and a fused-fiber-type (or branch-coupler-type) light monitoring method shown in FIG. 4B have been known.

According to the spatial-propagation-type light monitoring method shown in FIG. 4A, after light propagating through an optical fiber 10 is converted into collimated light by a collimator 3, and thereafter, a portion of the collimated light is extracted by a beam splitter 4 as monitor light and is received by a light receiving element 2.

Further, according to the fused-fiber-type light monitoring method shown in FIG. 4B, after light propagating through the optical fiber 10 is branched by a light fused-fiber coupler 6, a portion of the branched light is extracted as monitor light, and is received by the light receiving element 2.

### DISCLOSURE OF THE INVENTION

### Problems to be Solved by the Invention

However, in the spatial-propagation-type light monitoring method, after monitoring the light, the monitor light needs to be concentrated on an output-side optical fiber 10 using a condensing lens 5. Further, since an optical system is complicated, the number of components is large. Since precise alignment is required, it is difficult to adjust optical components.

Further, in the fused-fiber-type light monitoring method, high cost is required when manufacturing the light fused-fiber coupler 6. Further, when the monitor light is received by the receiving element 2, a lens 7 is needed, which increases the number of components.

Accordingly, a method has been required in which the number of components can be reduced, and light propagating through an optical fiber can be monitored with a simple structure.

In consideration of the above-described problems, an object of the present invention is to provide a light monitoring method and a light monitoring apparatus by means of which monitoring light propagating through an optical fiber can be carried out with a simple structure having a small number of components without causing a large connection loss or Fresnel reflection, and performing precise adjustment of optical components.

### Means for Solving the Problems

In order to solve the above-described problems, according to a first aspect of the invention, there is provided a light monitoring method, characterized in that light leaking from abutting portions that are formed by abutting end faces of optical fibers is received.

According to a second aspect of the invention, in the light monitoring method according to the first aspect of the invention, a light transmitting connecting member is provided to cover the abutting portions.

According to a third aspect of the invention, a light monitoring apparatus is provided, characterized in that it includes: a light receiving element; and an optical fiber holding structure which is disposed in the vicinity of the light receiving element and which forms abutting portions by abutting end faces of two optical fibers while holding the two optical fibers.

### EFFECTS OF THE INVENTION

According to the light monitoring method and apparatus according aspects of the invention, since the light leaking from the abutting portions formed by abutting the end faces of the optical fibers is received, the light propagating through the optical fibers can be monitored with a simple structure without causing a large connection loss or Fresnel reflection, and performing precise adjustment of optical components.

### BRIEF DESCRIPTION OF THE DRAWINGS

FIG. 1 is a general cross-sectional view illustrating a first embodied apparatus according to the present invention.

FIG. 2 is a general cross-sectional view illustrating a second embodied apparatus according to the present invention.

FIG. 3 is a general cross-sectional view illustrating a third embodied apparatus according to the present invention.

FIG. 4A is a general view illustrating a schematic structure implementing a conventional light monitoring method of spatial-propagation-type.

FIG. 4B is a general view illustrating a schematic structure implementing a conventional light monitoring method of fused-fiber-type.

### DESCRIPTION OF REFERENCE NUMERALS

1: LIGHT MONITORING APPARATUS
2: LIGHT RECEIVING ELEMENT
10: OPTICAL FIBER
30: ABUTTING PORTION
40: CONNECTING MEMBER

### BEST MODE FOR CARRYING OUT THE INVENTION

With reference to the drawings, a plurality of embodiments of the present invention will now be described. However, it is not to be argued that the present invention is not meant to be limited to these embodiments.

### First Embodiment

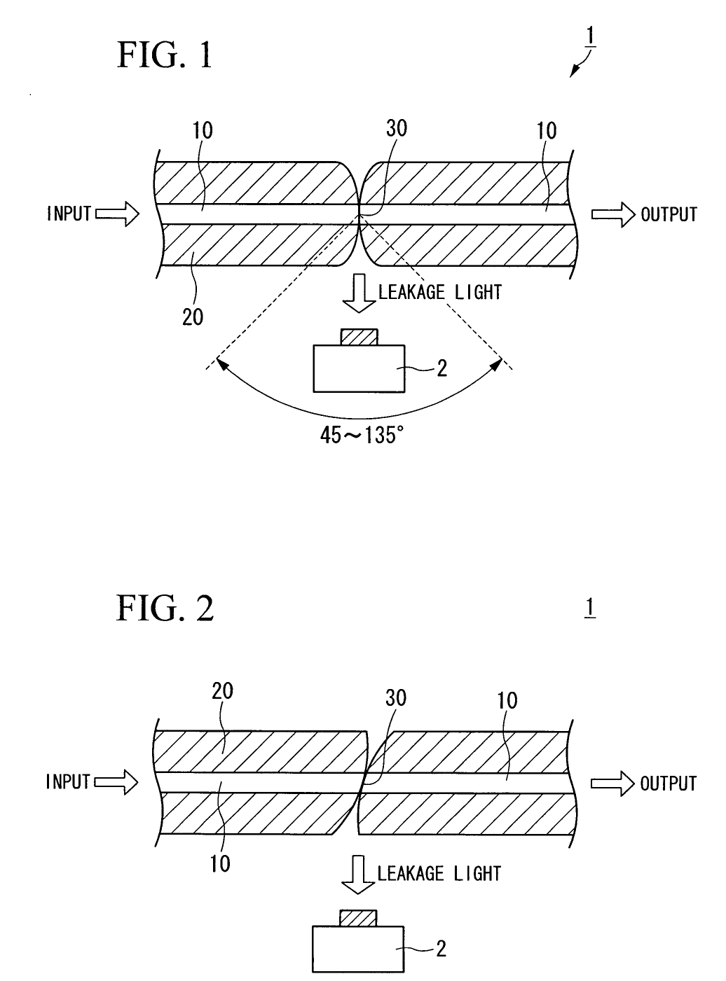

In FIG. 1, a light monitoring apparatus 1 includes two optical fibers 10 and 10 each having an end face, an optical fiber holding mechanism (not shown) that abuts the end faces of the optical fibers so as to form abutting portions 30, while holding the two optical fibers 10 and 10, and a light receiving element 2 that is disposed in the vicinity of the optical fiber holding mechanism and receives light leaking from the abutting portions 30.

Each of the optical fibers 10 has a core and a clad, and is covered with a transparent resin layer 20. Further, the optical fibers 10 and 10 are constructed such that the optical fibers 10 and 10 are held by the optical fiber holding mechanism (not shown), such as a clamp, and that the end faces of the optical fibers 10 and 10 abut each other so as to form the abutting portions 10. Further, the abutting portions 30 are obtained by polishing the end faces of the two optical fibers 10 and 10 to form convex spherical shapes and rendering the end faces to abut each other.

Further, the light receiving element 2 monitors a small amount of light in a range of 1 to 2% (0.05 to 0.1 dB) that leaks from the abutting portions 30. As the light receiving element 2, light receiving elements, which are generally used when monitoring light in an optical fiber, can be used. The light receiving element 2 is disposed in the vicinity of the optical fiber holding mechanism. In order to assure detection of the light leaking from the abutting portions 30, it is preferable that the light receiving element 2 is disposed on a lateral surface side of the abutting portions 30, and it is more preferable that the light receiving element 2 is disposed at an angle in a range of 45 to 135° with respect to the end faces of the optical fibers 10.

Generally, when the optical fibers are connected to each other, the optical fibers are connected in such a manner that the end faces of the two optical fibers abut each other so as to form the abutting portion, thereby propagating light. At this time, if a gap is formed between the two optical fibers, Fresnel reflection occurs at the interface between the optical fibers and air, whereby a large connection loss is generated. In order to prevent this, the gap is filled with a resin (matching agent) that has the same reflection index as the optical fibers, such that the two optical fibers are connected to each other without the gap. Alternatively, the two optical fibers are connected to each other through a so-called physical contact (PC) connection in which the end faces of the optical fibers are polished and then directly contacted or closely adhered to each other.

In the case where the optical fibers are connected by using the physical contact method, if the optical fibers abut by polishing the end faces of the optical fibers in a shape other than a right-angled shape, a small amount of light leaks from the abutting portions.

In the present embodiment, when the two optical fibers 10 and 10 are connected to each other, the end faces of the optical fibers 10 and 10 are polished in a convex spherical shape so as to abut each other, light in a range of 1 to 2% (0.05 to 0.1 dB) leaks from the abutting portions 30, and the leakage light is received by the light receiving element 2. If the end faces of the optical fibers 10 and 10 are polished in a convex spherical shape so as to abut each other, light in a range of 98 to 99% can propagate and a small amount of light in a range of 1 to 2% can be extracted from the abutting portions 30 as the leakage light.

According to the present embodiment, it is simply required to form the abutting portions 30 that are obtained by abutting the end faces of the two optical fibers 10 and 10. Even with this simple structure, the light propagating through the optical fibers can be monitored with no precise adjustment of the optical components.

Hereinafter, a description will be given of a light monitoring method according to the present embodiment.

Firstly, the end faces of the two optical fibers 10 and 10 and coating resins 20 and 20 are polished in a convex spherical shape by a polishing machine. It is preferable that the curvature of the end face be of slightly curved shape so that the optical fibers 10 and 10 closely adhere to each other.

Then, the abutting portions 30 are formed by abutting the end faces of the optical fibers, and the light leaking from the abutting portions 30 is received by the light receiving element 2 disposed in the vicinity of the abutting portions 30.

According to the light monitoring method with respect to the present embodiment, since the light leaking from the abutting portions 30 formed by abutting the end faces of the optical fibers 10 and 10 is received, it is possible to monitor the light propagating through the optical fibers without accompanying a large connection loss and Fresnel reflection.

### Second Embodiment

In FIG. 2, a light monitoring apparatus 1 according to a second embodiment is the same as the light monitoring apparatus according to the first embodiment, except in that the end faces of the two optical fibers 10 and 10 abut each other by polishing the end faces in an inclined shape. As such, further descriptions thereof are omitted to avoid duplicate description.

According to the second embodiment, since the end faces of the two optical fibers 10 and 10 abut each other by polishing the end faces in the inclined shape, the returning of the reflected light can be further reduced, and the two optical fibers 10 and 10 can be suppressed from rotating around the axes.

### Third Embodiment

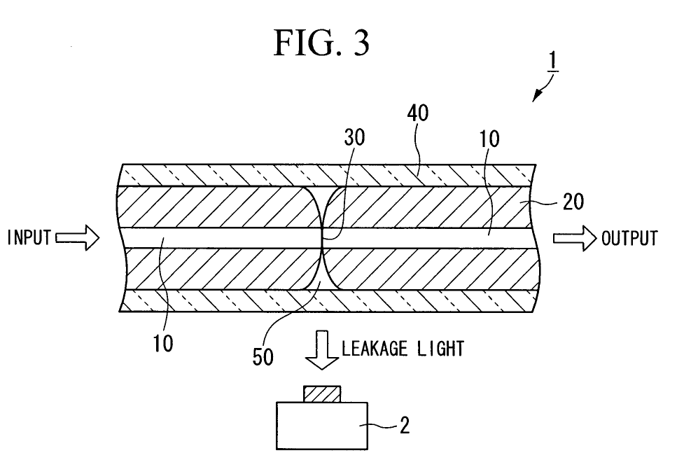

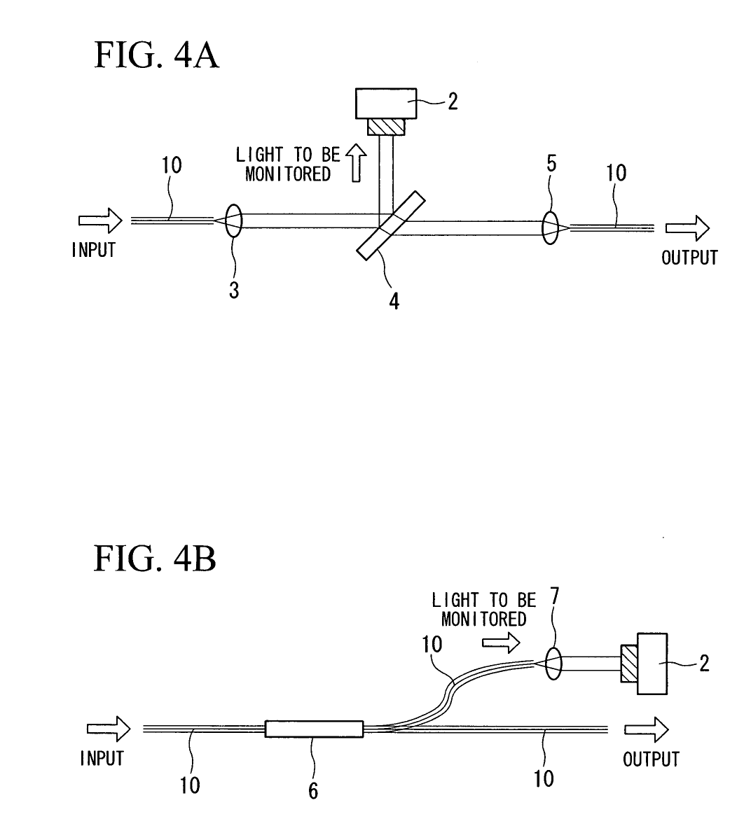

In FIG. 3, a light monitoring apparatus 1 according to a third embodiment is the same as the light monitoring apparatus according to the first embodiment, except that outside the coating resins 20 and 20, a light transmitting connecting member 40 is provided in order to cover the abutting portions 30. As such, further descriptions thereof are omitted to avoid duplicate description.

The connecting member 40 which is used for fixedly connecting the end faces of the two optical fibers 10 and 10 has a light transmitting property capable of transmitting the light which has leaked from the abutting portions 30. For example, the connecting member 40 may be formed of transparent adhesive resin which is solidified, or may be a ferrule or a sleeve formed of a transparent material. Alternatively, a connecting member available in the market such as a ferrule, a sleeve or the like, made of a metal or ceramic, with a small aperture or a window additionally pierced for passing light therethrough, may be used. Further, the connecting member 40 may be an unitary one, or may be structured by two or more connecting members such that the end faces of the two optical fibers 10 and 10 are fixedly secured.

As described, with the connecting member 40 additionally provided for covering the abutting portions 30, the two optical fibers 10 and 10 can be more firmly connected to each other.

In the present embodiment, although a space 50 between the abutting portions 30 and the connecting member 40 is not filled, the space 50 may be filled with an adhesive, matching oil or the like. For example, when the adhesive is filled into the space 50, the optical fibers 10 and 10 can be firmly fixed. Thus, even when optical fibers are used in submarine communication, it is possible to ensure sufficient strength of the optical fibers.

As an example of the adhesive or the matching oil to be filled in the space 50, adhesive that has a refractive index substantially equal to a refraction index 1.45 of a core may be used whereby a receivable amount of leakage light can be extracted form the abutting portions 30. For example, ultraviolet cure adhesive UV-1100 of Daikin Industries, Ltd. or the like may be used.

Further, in the present embodiment, the light receiving element 2 is disposed on the outer side of the connecting member 40 such that the light receiving element receives the leakage light transmitting the connecting member 40. However, if the light receiving element 2 is extremely small in size, a structure is possible in which the light receiving element is disposed in the vicinity of the abutting portions 30 so as to directly receive the leakage light.

1.-3. (canceled)

4. A light monitoring method, comprising:
providing optical fibers which are connected such that end faces of the optical fibers abut so as to form abutting portions; and
receiving light leaking from the abutting portions.

5. The light monitoring method as recited in claim 4, wherein each of the end faces of the optical fibers is of convex spherical shape.

6. The light monitoring method as recited in claim 4, wherein the end faces of the optical fibers are connected through a physical contact connection.

7. The light monitoring method as recited in claim 4, further comprising a light transmitting connecting member which is provided to cover the abutting portions.

8. A light monitoring apparatus, comprising:
a light receiving element; and
an optical fiber holding structure which is disposed in the vicinity of the light receiving element and which forms abutting portions by abutting end faces of two optical fibers while holding the two optical fibers.

9. The light monitoring apparatus as recited in claim 8, wherein each of the end faces of the two optical fibers is of convex spherical shape.

10. The light monitoring apparatus as recited in claim 8, wherein the end faces of the optical fibers are connected through a physical contact connection.

11. The light monitoring apparatus as recited in claim 8, further comprising a light transmitting connecting a member which is provided to cover the abutting portions.
